(19) United States
(12) Patent Application Publication
(10) Pub. No.: US 2017/0190060 A1
(43) Pub. Date: Jul. 6, 2017

(54) DRYWALL CUTTING DEVICE

(71) Applicant: William Bridgeman, Pampa, TX (US)

(72) Inventor: William Bridgeman, Pampa, TX (US)

(21) Appl. No.: 14/988,199

(22) Filed: Jan. 5, 2016

(51) Int. Cl. B26B 13/26; B26B 13/14

(52) U.S. Cl. CPC B26B 13/26; B26B 13/14

(57) ABSTRACT

A cutting device configured to cut drywall structures includes an elongate body of generally curved geometry, a forearm holding section positioned at a distal end of the elongate body, multiple retractable knifes hingedly connected at an opposing distal end of the elongate body, and a hand holding section positioned substantially at a mid-portion of the elongate body, where a user supports a forearm of the user at the forearm holding section, and holds the hand holding section using hands to cut the drywall.

### BACKGROUND

Sheet formed materials, for example, drywalls are normally used for wall covering in the building of houses. These materials defined in sheet form are generally supplied in designated geometries. When mounting these sheets it is often essential to cut strips of unvarying width and this is normally done by using a knife member, in combination with a measuring tape. One end of the measuring tape is positioned at the side of the knife member using the thumb and the tape is extended across the sheet to an anticipated width, holding the tape alongside the edge of the sheet. With the measuring tape is positioned in one hand and the knife member in the other hand, both the hands are traversed down the sheet section concurrently such that the knife slashes a line parallel to the edge portion of the sheet. The last cut is therefore made without the measuring tape via the knife member along the scored line, and the sheet is consequently bent along the cut line till it's broken, resulting in a strip of the anticipated width.

Commonly, it is not practicable to apply satisfactory pressure to the knife member to mark the essential cut in one single pass across the sheet section when using the aforementioned method due to the design of the knife member. Further, tremendous difficulties are regularly faced when concurrently measuring and cutting the sheet sections in the method as mentioned above, for example, the knife member slippage, or imprecise scoring using the knife member. These difficulties can effectively in waste time and materials thus adding to the construction cost.

Hence, there is a long felt but unresolved need for a cutting device which a user can comfortably hold using the hands and forearms to define a cut on a drywall.

### SUMMARY OF THE INVENTION

The cutting device described herein addresses the above mentioned need for a knife unit cutting device which a user can comfortably hold using the hands and forearms to define a cut on a drywall. A cutting device configured to cut drywall structures, comprises an elongate body of generally curved geometry, a forearm holding section positioned at a distal end of the elongate body, multiple retractable knifes hingedly connected at an opposing distal end of the elongate body, and a hand holding section positioned substantially at a mid-portion of the elongate body, where a user supports a forearm of the user at the forearm holding section, and holds the hand holding section using hands to cut the drywall.

In an embodiment, the cutting device disclosed herein further comprises a first gripping member configured to cover the forearm holding section. In an embodiment, the cutting device disclosed herein further comprises a second gripping member configured to cover the hand holding section. In an embodiment, the retractable knifes are positioned within a trap door defined at the opposing distal end of the elongate body. In an embodiment, the first gripping member is made of plastic. In an embodiment, the second gripping member is made of plastic.

### BRIEF DESCRIPTION OF THE DRAWINGS

FIG. 1A exemplarily illustrates a front perspective view of the cutting device being used on a drywall.

FIG. 1B exemplarily illustrates an enlarged view of the portion marked A in FIG. 1A, showing the cutting device.

### DETAILED DESCRIPTION OF THE INVENTION

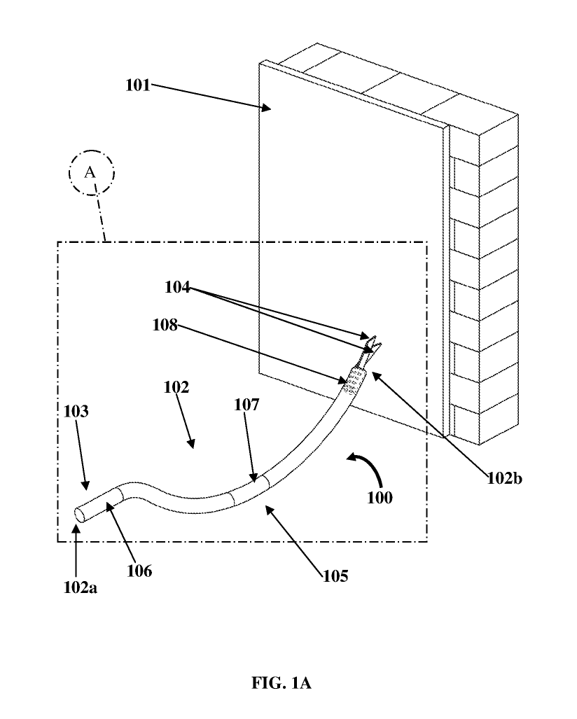

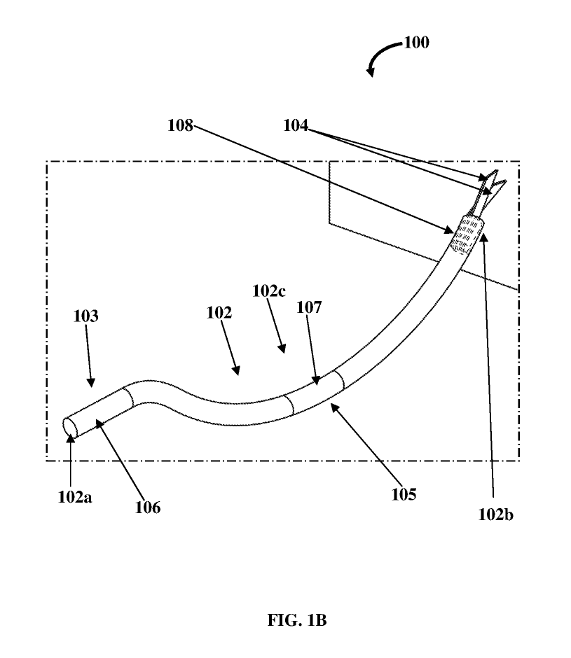

FIG. 1A exemplarily illustrates a front perspective view of the cutting device 100 being used on a drywall, and FIG. 1B exemplarily illustrates an enlarged view of the portion marked A in FIG. 1A, showing the cutting device 100. The cutting device 100 described herein addresses the above mentioned need for a knife unit cutting device 100 which a user can comfortably hold using the hands and forearms to define a cut on a drywall structure 101. A cutting device 100, for example, 34 inches in length, configured to cut a drywall structure 101 comprises an elongate body 102 of generally curved geometry, a forearm holding section 103 positioned at a distal end 102a of the elongate body 102, multiple retractable knifes 104 hingedly connected at an opposing distal end 102b of the elongate body 102, and a hand holding section 105 positioned substantially at a mid-portion 102c of the elongate body 102, where a user supports a forearm of the user at the forearm holding section 103, and holds the hand holding section 105 using hands to cut the drywall structure 101.

In an embodiment, the cutting device 100 disclosed herein further comprises a first gripping member 106 configured to cover the forearm holding section 103. In an embodiment, the cutting device 100 disclosed herein further comprises a second gripping member 107 configured to cover the hand holding section 105. In an embodiment, the retractable knifes 104 are positioned within a trap door 108 defined at the opposing distal end 102b of the elongate body 102. In an embodiment, the first gripping member 106 is made of plastic. In an embodiment, the second gripping member 107 is made of plastic. The cutting device 100 enable the user to apply adequate pressure on the retractable knifes 104 to form a cut of satisfactory depth in a single pass to allow the drywall structure 101 to be fragmented along the slash line. The cutting device 100 further improves the cutting accuracy as associated with devices using utility knifes. Further, cutting device 100 is highly portable, in contrast with conventional drywall cutting mechanisms which utilizing T-square sections. Significantly, the means by which the cutting device 100 are attached to the measuring tape do not use clamping apparatuses such as fasteners which are enforced onto the surface of the tape, since fasteners which are enforced into connection with a measuring tape are known to cause severe distortion and damage the tape.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A cutting device configured to cut drywall structures, comprising:
an elongate body of generally curved geometry;
a forearm holding section positioned at a distal end of the elongate body;
a plurality of retractable knifes hingedly connected at an opposing distal end of the elongate body; and
a hand holding section positioned substantially at a mid-portion of the elongate body, wherein a user supports a forearm of the user at the forearm holding section, and holds the hand holding section using hands to cut the drywall.

2. The cutting device of claim 1, further comprising a first gripping member configured to cover the forearm holding section.

3. The cutting device of claim 1, further comprising a second gripping member configured to cover the hand holding section.

4. The cutting device of claim 1, wherein the retractable knifes are positioned within a trap door defined at the opposing distal end of the elongate body.

5. The cutting device of claim 2, wherein the first gripping member is made of plastic.

6. The cutting device of claim 3, wherein the second gripping member is made of plastic.
